(19) United States
(12) Patent Application Publication
(10) Pub. No.: US 2014/0136542 A1
(43) Pub. Date: May 15, 2014

(54) System and Method for Divisive Textual Clustering by Label Selection Using Variant-Weighted TFIDF

(71) Applicant: Apple Inc., Cupertino, CA (US)

(72) Inventor: Edwin Cooper, Oakland, CA (US)

(73) Assignee: APPLE INC., Cupertino, CA (US)

(21) Appl. No.: 14/076,098

(22) Filed: Nov. 8, 2013

Related U.S. Application Data
(60) Provisional application No. 61/724,222, filed on Nov. 8, 2012.

(51) Int. Cl. G06F 17/30

(52) U.S. Cl. CPC G06F 17/30598
USPC 707/740

(57) ABSTRACT

A computer implemented method includes accepting a corpus of documents organized in categories. Labels are selected for the categories based upon author frequency-inverse document frequency criteria that measures the total number of authors who utilize a given term within a category in comparison to the total number of authors who utilize the term both inside the category and outside the category. Clusters within each category are created based upon the labels. Each document in a cluster contains the term selected as a label for the cluster.

### CROSS-REFERENCE TO RELATED APPLICATION

This application claims priority to U.S. Provisional Patent Application 61/724,222, filed Nov. 8, 2012, the contents of which are incorporated herein by reference.

### FIELD OF INVENTION

This invention relates generally to the clustering of objects. More particularly, this invention relates to aggregating documents into clusters recursively by the application of a variant of the Term-Frequency/Inverse Document Frequency (TFIDF) information retrieval measurement.

### BACKGROUND

### Definitions:

Dendrogram: a tree diagram illustrating the arrangement of clusters produced by hierarchical clustering. The dendrogram may be a hierarchy of document clusters created through a hierarchical clustering algorithm, where each node of the dendrogram hierarchy represents a specific cluster of documents. In such a dendrogram, every cluster has exactly one parent, except for the ‘root node’, which has no parents. Note that every node may have an arbitrary number of children, and that any document may appear in any number of clusters.

Cluster: A node within a dendrogram. A given cluster may contain any number of documents, but must contain at least one document.

Cluster Label: A textual description for a document cluster intended to textually represent the documents within the cluster. Cluster labels are typically short (often individual words or phrases) and are often drawn from the text of some document contained within the cluster. However, in most clustering techniques the cluster label chosen does not appear in every document in that cluster.

FIG. 1 illustrates top-down, divisive text document clustering. In particular, a corpus of documents 100 is organized to include a first hierarchical layer 102 and a second hierarchical layer 104.

In the last forty years automated document clustering has emerged as a valuable technique for making large corpora of documents tractable to a given user. When confronted with a large number of documents (e.g., 100,000 or more), it is useful for a user to have those documents automatically divided into categories, each containing documents relevant to that category. Further, it is useful to have those categories divided into subcategories and so on until every document is contained within a cluster of documents of tractable size or some other suitable stopping condition is met. Well-established techniques for document clustering include k-means clustering and Latent Semantic Analysis. Existing clustering techniques generally present a tradeoff between system performance/speed and the semantic coherence of produced clusters (i.e., the success with which the technique is able to separate documents of separate subject matter into separate clusters).

In general, clustering techniques follow two major methodologies: divisive (top-down) and agglomerative (bottom-up). In the former top-down type of clustering, the entire initial set of documents is divided into categories of documents and then those categories are recursively divided into smaller subcategories. In the latter, bottom-up type of clustering, all individual documents are first agglomerated into many small categories, which are then combined into larger categories, and so on until all document clusters are combined into one final, root cluster.

The use of the TFIDF technique is widespread in the field of Information Retrieval. The origin of the technique is with Stephen Robertson and Karen Sparck Jones (Jones KS (1972). “A statistical interpretation of term specificity and its application in retrieval”. Journal of Documentation 28 (1): 11-21. doi:10.1108/eb026526.).

In the years since it was first introduced, a variety of applications and alternatives to TFIDF have emerged. These include “TFICF” as opposed to TFIDF, the Okapi variant, the LTU variant, and others.

By far the most typical use of TFIDF is as a means of weighting terms for purposes of information retrieval. Given a corpus of documents, a term within any one of those documents may be taken to be more or less important, based on its TFIDF score.

A TFIDF score is calculated for a particular term within a particular document, where that document is one of many documents within the corpus. By computing TFIDF scores for each of the terms in a given retrieved document, the relevance of that document to a search query can be estimated. When a search engine query results in a set of matching relevant documents being delivered to a user, TFIDF weighting has typically been applied both to the terms in the query and those in the returned documents (among a variety of other indications that a given search engine may incorporate).

However, it is important to note that, despite its typical use, the application of the TFIDF algorithm is not inherently limited to information retrieval purposes. Given any set of documents, each term in any of those documents may be assigned an ‘importance’ based on its TFIDF measurement relative to other documents in that corpus.

Essentially, all variants of TFIDF incorporate two components. First, they incorporate a TF, or term frequency, component. This component measures the frequency of a given term within a given document. The second component is the IDF, or inverse document frequency, component. This component measures the inverse of the frequency of the same term over the entire corpus of documents. Thus, the greater the number of occurrences of a term in a document, the greater the TF component, and the fewer documents in the corpus that contain that term, the greater the IDF component. Intuitively, a TFIDF score is high for a term in a document when that term appears often in that document, but that same term appears infrequently in the corpus as a whole. FIG. 2 illustrates a standard implementation of the TFIDF measurement of term importance within the context of a corpus of documents.

### SUMMARY OF THE INVENTION

A computer implemented method includes accepting a corpus of documents organized in categories. Labels are selected for the categories based upon author frequency-inverse document frequency criteria that measures the total number of authors who utilize a given term within a category in comparison to the total number of authors who utilize the term both inside the category and outside the category. Clusters within each category are created based upon the labels. Each document in a cluster contains the term selected as a label for the cluster.

A computer implemented method includes accepting a corpus of documents organized in categories. Labels are selected for the categories based upon the ratio of authors that use a term within a category to all authors that use the term in all categories. Clusters within each category are created based upon the labels. Cluster label criteria is altered to produce more distinctive labels. Labels are selected for the clusters based upon the ratio of authors that use a term within a cluster to all authors that use the term in all clusters.

### BRIEF DESCRIPTION OF THE FIGURES

The invention is more fully appreciated in connection with the following detailed description taken in conjunction with the accompanying drawings, in which:

FIG. 1 illustrates divisive (top-down) text-based document clustering.

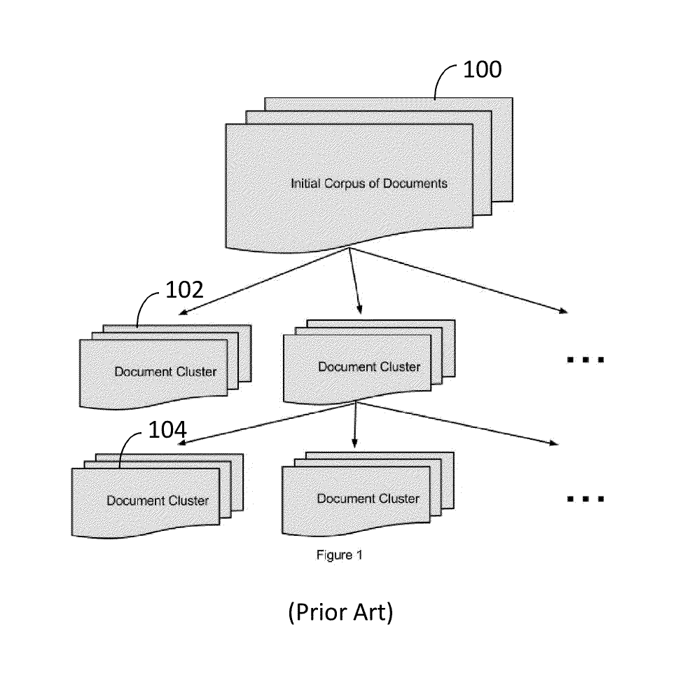

FIG. 2 illustrates the concept of Term Frequency, Inverse Document Frequency.

FIG. 3 is an example of an existing clustering technique with document semantic coherence as primary goal.

FIG. 4 illustrates an Author Frequency, Inverse Author Frequency TFIDF technique.

FIG. 5 illustrates a dendrogram-level-based Inverse Author Frequency weighting technique.

FIG. 6 illustrates sample output achieved in accordance with an embodiment of the invention.

FIG. 7 illustrates a computer configured to implement operations of the invention.

Like reference numerals refer to corresponding parts throughout the several views of the drawings.

### DETAILED DESCRIPTION

This disclosure describes a novel method of top-down, divisive text clustering. The technique is applied recursively to an arbitrarily large number of documents. It adopts the TFIDF technique from the field of information retrieval and modifies it so as to produce a clustering methodology with unusually good cluster label selection.

The TFIDF variant described here differs from the existing standard TFIDF measurement and its typical application in three significant ways. First, it is applied within pre-existing categories as a means of determining labels for potential subcategories. This application differs from TFIDF's more standard role in weighting terms for information retrieval purposes. Second, the variant described here takes into account not just the frequency of terms, but also the frequency of individual authors' appearances in the corpus of documents. In a corpus of documents with many documents originating from the same author, this normalization significantly improves label selection quality. Third, in the variant described here the TFIDF measurement is normalized with regard to the position of the cluster being produced within the containing dendrogram.

In addition to the unusually high quality cluster labels produced by this technique, the related cluster label-selection has the property that cluster labels will consist of words and phrases that will necessarily appear in every document contained in that cluster. As a result, documents in clusters may be presented in a manner similar to search results, with each of the labels that apply to a given document emphasized, much like query terms are emphasized in a search engine's delivered results. The presentation of clustering results to users in a form similar to search results provides additional user familiarity, allowing the user to see search-engine-like results within the context of a dendrogram, without entering a search query. This familiarity of presentation further improves the value provided by the initial clustering and the ultimate browseability of the documents within the produced dendrogram.

In a world where billions of digitized documents exist, technologies that make large sets of documents more tractable are in significant demand. One such area of technology is the search engine. By submitting a query, a user may restrict the set of available documents to those most relevant to the query. Another such technological area is that of document clustering; by automatically creating groups (clusters') within a large set of documents, that large set of documents can be divided into consumable parts, and thereby made tractable to a given user or set of users. Given a hierarchy of document clusters, each with a descriptive label, a user may browse quickly to those subject areas of greatest interest, and may further refine the chosen subject area through choosing an appropriate subcategory. Assuming that the clustering technique is applied recursively until no more that a pre-specified number of documents exist in a cluster, the user may browse document to an arbitrary degree of specificity in terms of clustered subject area.

For purposes of illustration, we describe the application of this technique to the App Store hosted by Apple®. That is, the technique was used to cluster the apps according to the text contained within their titles and descriptions.

The most common stated goal of existing clustering techniques is that of providing semantically distinct clusters. For example, suppose a set of 100,000 documents were chosen at random from the World Wide Web, the only criterion being that they all contain the word ‘windows’. Some of the randomly chosen documents would concern household building materials and panes of glass, while others would relate to operating system issues (i.e., issues related to the Microsoft® Windows® operating system). Most existing clustering techniques take as their primary goal the separation of such documents into semantically distinct clusters; in this case, one cluster would contain panes of glass documents and the other would contain operating system documents. Much of the literature surrounding document clustering implicitly takes the creation of such distinctive semantic clusters as its primary goal (k-means clustering and latent semantic techniques are both examples).

Having first separated documents into semantically distinct clusters, leading clustering techniques have the secondary goal of finding an appropriate label for each cluster. Such a label may be used to describe the entire cluster and is typically a single word or phrase. It is important to note that most clustering techniques do not take as a requirement that the cluster label exist in the text of each of the documents within that cluster. To illustrate: suppose a standard clustering technique (e.g., k-means) successfully divided the example set of 100,000 documents into a panes-of-glass cluster and an operating system cluster. The selected label for the second cluster might be ‘operating systems’, even though the phrase ‘operating system’ occurred only in some of the documents in that cluster.

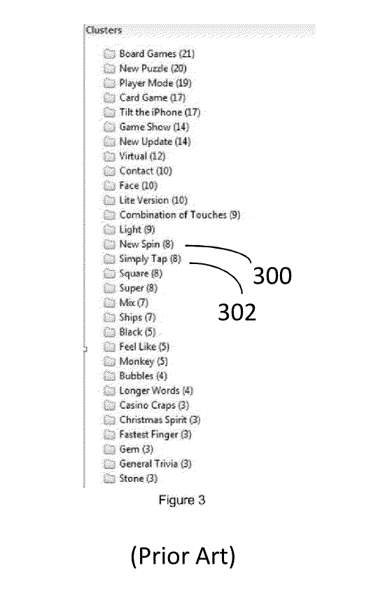

In practice, existing text clustering techniques are often quite successful in their primary goal of dividing documents into semantically distinct clusters and significantly less successful in discovering useful labels for those clusters. As an illustrating example, the output of a leading open-source clustering technique (“Carrot2”) is shown in FIG. 3, as it was applied to the text descriptions of Game apps from Apple's App Store.

Note that this known, leading clustering technique may have succeeded in its primary goal of creating semantically distinct clusters of the given documents. However, its success in its secondary goal of creating readable, useful labels is less impressive. For example: the sets of documents in the clusters may be semantically coherent, concerning the same subject and ideas; but the labels ‘New Spin’ 300 and ‘Simply Tap’ 302 do not convey sufficient meaning to the user about those documents (in this example, about the apps contained within those clusters). Because the primary goal of this clustering technique was to assemble documents into semantically coherent clusters, the secondary goal of creating high-quality cluster labels has suffered in comparison.

In the present invention, we describe a clustering technique which takes the discovery of useful, readable, cluster labels as its primary goal, and the creation of semantically distinct clusters of documents under those labels as its secondary goal.

As noted earlier, TFIDF is typically used in the context of information retrieval, as a means to weight terms for purposes of query-based search. However, it may be applied with great effect outside the scope of information retrieval for purposes of label selection and cluster definition.

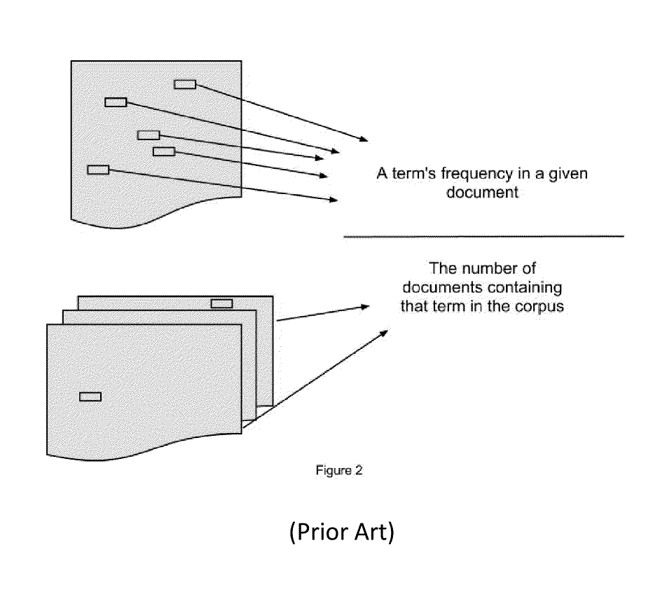

TFIDF is usually defined as (and named after) a means for the selection of weights for terms within a document, where that document is part of a larger set of documents. The Term Frequency component refers to the frequency of a term within the document and the inverse document frequency component refers to occurrence of that term in the set of documents as a whole, as shown in FIG. 2. Indeed, the name ‘TFIDF’ is based on this standard application of these two scoring components.

However, the same two components of this evaluation may be conceptually applied to compare term frequencies for documents within a category, and documents outside that category. That is, the term frequency component can be measured as the frequency of appearance of terms within a given category of documents and the document frequency component can be measured as the frequency of the same term throughout all documents of every category. Thus, instead of Term Frequency, Inverse Document Frequency, we can measure Term Category Frequency, Inverse Term Frequency. This application of the components of the TFIDF measurement to categories of documents differs significantly from the typical application of TFIDF within the context of term-weighting for individual documents, but is conceptually parallel.

When TFIDF is applied not to an individual document, but to an entire category, it will in general supply terms of importance for that category. These terms can be used as labels for the category, describing as they do important aspects of the category, which differentiate it from the corpus of documents as a whole.

The usual application of TFIDF (where terms are weighted within a single document) has little need to take into account the authorship of that single document (TFIDF is typically applied to terms in a single document, with a single author). However, when TFIDF is applied in the nonstandard context of comparing documents within a category to those outside that category, there may be multiple authors of documents within that category, and it becomes useful to take authorship into account in creating an effective measure of term-category importance.

We have found that, when applied as a means of cluster label identification within a category, normalization by author is necessary for the creation of high-quality cluster labels. Rather than measuring the term frequency within and outside that category, superior label selection can be achieved by measuring the ‘author frequency’ of documents inside and outside that category, where ‘author frequency’ refers to the number of authors who utilize a given term. Thus, TFIDF becomes AFIDF and conceptually measures the total number of authors who utilize a given term within a category, in comparison to the total number of authors who utilize that term both inside and outside the category.

This normalization by author has the beneficial side effect of removing undue weight from any single author that may be overrepresented within a particular category. In its usual application, normalization by author is not relevant to the TFIDF measure, but in its application for label selection within a category, it is a necessary step for high-quality cluster label production.

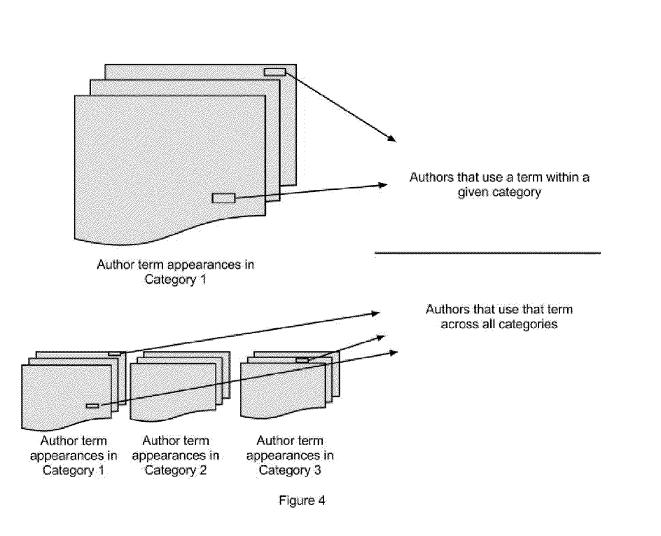

FIG. 4 contains an illustration of the AFIAF measure applied within the context of categories of documents and normalized by author. This figure illustrates the selection of a label for ‘Category 1’. A given term that occurs in Category 1 is judged both by the number of appearances of that term in documents by unique authors within Category 1 and by the number of appearances of that term in documents by unique authors within all categories. The resulting measure is the ratio of that term's author frequency within the category in question to its frequency within the set of all documents in all categories.

As noted above, TFIDF can be applied to the selection of terms within one category of documents in comparison to the same term throughout all categories of document. Furthermore, the application of TFIDF (or its variant) within the context of document categories can be applied recursively, so as to create a hierarchy of document clusters (a dendrogram). The process is as follows:

Given a corpus of documents, each of which is associated with one or more initial, top-level categories:
1. For each of those initial categories, select the best labels for that category, based on the TFIDF variant described here.
2. Create clusters within each category from the labels selected for that category. The documents contained within those clusters are those documents containing the term selected as a label for that cluster. (There may be additional selection criteria for documents within a created cluster, such as a relevance threshold for that document for the selected label).
3. Repeat this divisive, top-down process recursively, until stopping conditions are met. For example, the recursive clustering process may end when every created cluster has fewer than a pre-specified number of documents in it.

Note that this application of a TFIDF variant within the context of categories is applicable only when a corpus of documents has been divided into top-level categories. Such is the case (for example) on Apple App Store, where every document is included in at least one high-level category, such as “Utilities” or “Weather”.

As noted earlier, the unusual application of TFIDF as a cluster label selection mechanism within pre-existing categories of documents creates the need for the adaptation of the technique, including the new requirement to normalize by unique authorship. A second adaptation is achieved through taking into account the level of the dendrogram hierarchy in which the variant TFIDF measure is being applied.

This modification can take several effective forms. Recall that this modified variant of TFIDF conceptually combines two components: the unique authors that utilize a given term within a pre-existing category and the total number of all authors utilizing that term both inside and outside that category. Further, this variant is applied recursively to create subcategories. As this recursive creation of subcategories (clusters) occurs, it is useful to influence the TFIDF variant measure by the remaining total of documents or authors within the set of documents still to be clustered.

For example, it may be desirable to produce category labels which are relatively common terms within the corpus. In this case, the TFIDF variant denominator could be increased by a constant multiple factor. Alternately, the need may be for less common, more distinctive labels to be chosen. In this case, that IDF variant factor would be increased by a constant multiple factor. Further, it may be useful for such a modification to depend on the number of remaining documents still to be clustered; whereas the top-level clusters may be suitably general, it may be desirable for the lower-level clusters to include less common terms. In each of these cases, the desired effect can be achieved by modification of the TFIDF variant with regard to the dendrogram level, the authors remaining, the documents remaining, or some other factor pertaining to the position within the dendrogram where the clustering is taking place or the number or type of documents contained within the relevant cluster or dendrogram as a whole.

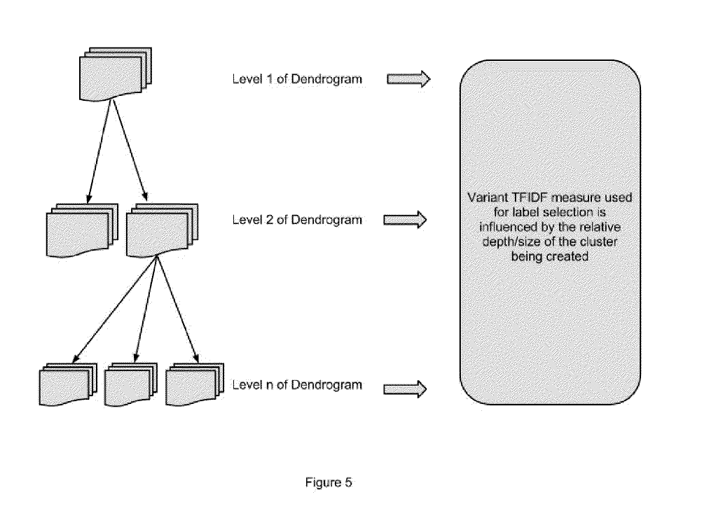

FIG. 5 illustrates the incorporation of dendrogrammatic level into the TFIDF variant used for dendrogram label selection. Here, the TFIDF-variant measure takes into account the absolute or relative depth and/or size of the current cluster being produced, in order to improve the ultimate quality of cluster labels selected.

The systems and methods described here have been implemented (as an illustrating example) on the Apple® App Store. Within this context, every app was considered an individual document, and its title and developer description used as the text of that document. By incorporation of the methods described here, a dendrogram was created which contained clusters of all apps, with descriptive labels selected for each.

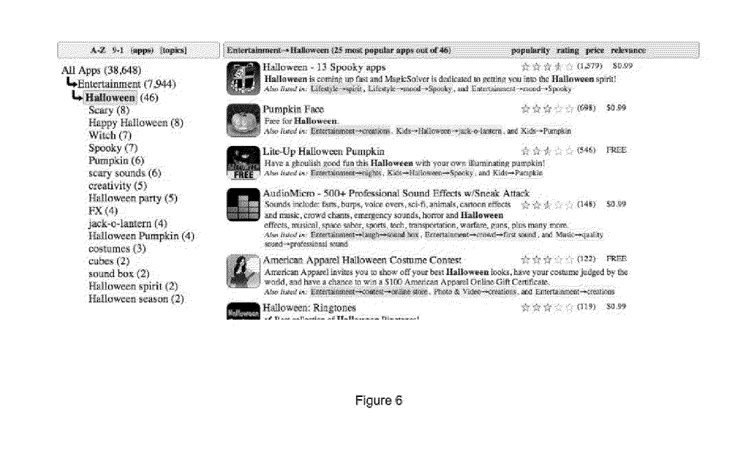

In this example embodiment, the ‘Entertainment’ category was a pre-defined category. The application of techniques described here created a “Halloween” category within that Entertainment category, and then created other subcategories within “Halloween”, including “spooky”, “scary”, etc. FIG. 6 represents a screenshot taken from this sample implementation.

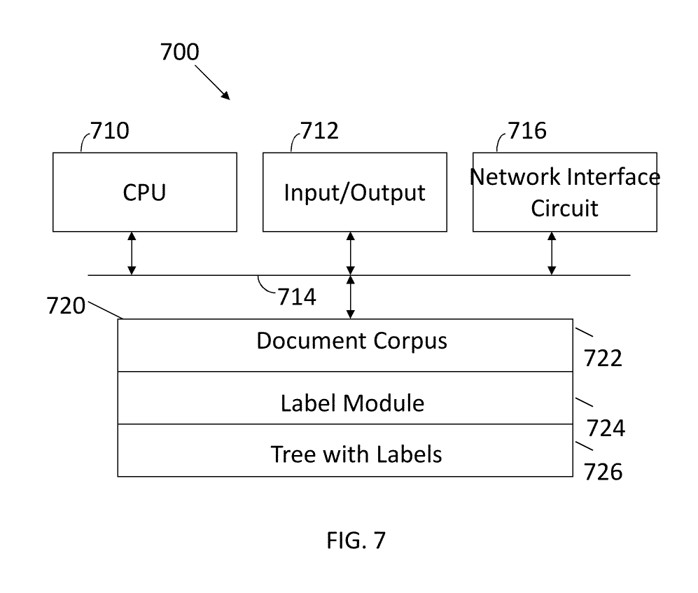

FIG. 7 illustrates a computer 700 configured in accordance with an embodiment of the invention. The computer 700 includes standard components, such as a central processing unit 710 and input/output devices 712 connected via a bus 714. The input/output devices 712 may include a keyboard, mouse, touch display and the like. A network interface circuit 716 is also connected to the bus 714 to provide connectivity to a network (not shown). A memory 720 is also connected to the bus 714. The memory 720 stores a document corpus 722. A label module 724 includes executable instructions to perform the operations described herein to produce a tree with labels 726. The tree with labels 726 is a multi-level dendrogram that may be supplied to a user, such as shown in FIG. 6.

In its usual formalization, text clustering takes as its primary goal the creation of semantically distinct document clusters and as a secondary goal the creation of high-quality cluster labels. Instead, we take the creation of high-quality labels as the primary clustering goal, and the selection of semantically distinct document clusters as the secondary goal.

In its usual application, TFIDF is used as a term-weighting mechanism for information retrieval. Instead, we apply TFIDF to the problem of intra-category label selection, using it to select terms representative of that category and recursively created subcategories.

We improve this unusual application of TFIDF in two ways. First, we normalize by unique author term usage. This normalization is not applicable to the standard TFIDF application. Second, we take into account the level of the created dendrogram in the modified TFIDF measurement. This modification is neither necessary nor applicable to the standard application of TFIDF.

Ultimately, we achieve a dendrogram containing unusually high-quality cluster labels. Such a dendrogram has a wide variety of uses. We have illustrated one such area of utility by a sample implementation within the context of an app Store.

An embodiment of the present invention relates to a computer storage product with a non-transitory computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media, optical media, magneto-optical media and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications, they thereby enable others skilled in the art to best utilize the invention and various embodiments with various modifications as are suited to the particular use contemplated. It is intended that the following claims and their equivalents define the scope of the invention.

1. A computer implemented method, comprising:
accepting a corpus of documents organized in categories; and
selecting labels for the categories based upon author frequency-inverse document frequency criteria that measures the total number of authors who utilize a given term within a category in comparison to the total number of authors who utilize the term both inside the category and outside the category.

2. The computer implemented method of claim 1 further comprising creating clusters within each category based upon the labels, wherein each document in a cluster contains the term selected as a label for the cluster.

3. The computer implemented method of claim 2 further comprising repeating the accepting, selecting and creating operations until a stop condition is met.

4. The computer implemented method of claim 3 wherein prior to repeating, altering cluster label criteria.

5. The computer implemented method of claim 4 wherein altering cluster label criteria includes altering cluster label criteria to produce labels for relatively common terms within the corpus.

6. The computer implemented method of claim 5 wherein altering cluster label criteria includes applying a multiple to the total number of authors who utilize the term both inside the category and outside the category.

7. The computer implemented method of claim 4 wherein altering cluster label criteria includes altering cluster label criteria to produce more distinctive labels.

8. The computer implemented method of claim 7 wherein altering cluster label criteria includes applying a multiple to the total number of authors who utilize a given term within a category.

9. The computer implemented method of claim 7 wherein altering cluster label criteria to produce more distinctive labels occurs for each additional operation of repeating.

10. The computer implemented method of claim 3 wherein the stop condition is a number of documents per cluster.

11. The computer implemented method of claim 3 wherein the accepting, selecting and creating operations produces a multi-level tree structure of clustered documents.

12. The computer implemented method of claim 11 further comprising presenting the multi-level tree structure of clustered documents to a user.

13. A computer implemented method, comprising:
accepting a corpus of documents organized in categories;
selecting labels for the categories based upon the ratio of authors that use a term within a category to all authors that use the term in all categories;
creating clusters within each category based upon the labels;
altering cluster label criteria to produce more distinctive labels; and
selecting labels for the clusters based upon the ratio of authors that use a term within a cluster to all authors that use the term in all clusters.

14. The computer implemented method of claim 13 wherein each document in a cluster contains the term selected as a label for the cluster, wherein the term matches the label or is semantically related to the label.

15. The computer implemented method of claim 13 producing a multi-level tree structure of clustered documents.

16. The computer implemented method of claim 15 further comprising presenting the multi-level tree structure of clustered documents to a user.
